(19) United States
(12) Patent Application Publication
(10) Pub. No.: US 2025/0013067 A1
(43) Pub. Date: Jan. 9, 2025

(54) DE-SPECKLE MECHANISM

(71) Applicant: Young Optics Inc., Hsinchu City (TW)

(72) Inventors: Kuan Lun CHENG, Hsinchu City (TW); Yu Chen CHANG, Hsinchu City (TW)

(73) Assignee: Young Optics Inc., Hsinchu City (TW)

(21) Appl. No.: 18/510,728

(22) Filed: Nov. 16, 2023

(30) Foreign Application Priority Data
Jul. 7, 2023 (TW) 112125523

(51) Int. Cl. G02B 27/48; G02B 5/02

(52) U.S. Cl. CPC G02B 27/48; G02B 5/0294

(57) ABSTRACT

A de-speckle mechanism includes a carrier, an optical homogenizer, an outer frame, a first flexible component, and a first actuator. The optical homogenizer is provided with a light-receiving surface and is disposed on the carrier. The outer frame is disposed adjacent to the carrier. The first flexible component is the only component connecting the carrier and the outer frame. The first actuator includes a first part and a second part which act relative to each other, and the first part is disposed on the carrier. The first actuator can drive the optical homogenizer, with the connecting position between the first flexible component and the outer frame as the fulcrum, so that the optical homogenizer can swing in a plane direction substantially parallel to or identical to the light-receiving surface of the optical homogenizer.

### RELATED APPLICATION

This application claims the benefit of priority of Taiwan Patent Application No. 112125523 filed on Jul. 7, 2023, the contents of which are incorporated by reference as if fully set forth herein in their entirety.

### FIELD

The present disclosure relates to display technologies, and more particularly, to a de-speckle mechanism.

### BACKGROUND

In a structure of a lighting and light combining system of a laser projector, light spots appear on a screen due to speckle effect of a laser light source. A conventional technology uses a diffuser in the lighting and light combining system. In order to achieve a better speckle elimination effect, a conventional technology makes the diffuser vibrate or rotate to achieve effect of eliminating speckles.

A conventional technology uses a wheel-shaped diffuser (diffuser wheel), and a motor rotates the wheel-shaped diffuser to achieve the effect of eliminating speckles. But this structure is bulky, and the motor has a lot of noise.

Chinese Patent No. CN112764297A discloses a dynamic diffuser assembly, which includes an upper moving part, a lower fixed part, four elastic supports, and four sets of magnet coils. The mechanism is complex and difficult to locate the upper moving part. It is not easy to adjust the vibration path and direction of the moving part. US Patent No. US20160306183 discloses an optical element for reducing speckle noise and discloses three or four elastic components with complex structures and three or four sets of magnet coils. Chinese Patent No. CN113641061B discloses a light beam speckle elimination device, which includes four pieces of elastic sheets with a relatively complex structure and two sets of magnet coils. It still does not solve the problems of difficult positioning and difficult adjustment of the vibration path and direction of moving part.

Chinese patent No. CN215264354U discloses a speckle eliminating device, including eight springs and four sets of magnet coil groups. In order to solve a problem that horizontal springs are difficult to maintain in a vertical direction, an arc-shaped protrusion is also provided below a mounting base to avoid positioning deviations in the vertical direction.

### SUMMARY

In view of the above, the present disclosure provides a de-speckle mechanism to effectively solve the problems of complex structure, difficult positioning, and difficulty in adjusting the vibration path and direction of moving parts in the prior art.

In order to achieve above-mentioned object of the present disclosure, one embodiment of the disclosure provides a de-speckle mechanism, including: a carrier, an optical homogenizer, an outer frame, a first flexible component, and a first actuator. The optical homogenizer is provided with a light-receiving surface and disposed on the carrier. The outer frame is disposed adjacent to the carrier. The first flexible component is an only component connecting the carrier and the outer frame. The first actuator includes a first part and a second part acting relative to each other. The first part is disposed on the carrier. The first actuator is configured to drive the optical homogenizer, with a connecting position between the first flexible component and the outer frame as a fulcrum, so that the optical homogenizer is configured to swing in a plane direction substantially parallel to or identical to the light-receiving surface of the optical homogenizer.

Another embodiment of the disclosure further provides a de-speckle mechanism, including: a carrier, an outer frame, a first flexible component, and a first actuator. The carrier includes an optical homogenizer. The optical homogenizer is provided with a light-receiving surface. The outer frame is disposed outside the carrier. The first flexible component is a main component substantially connecting the carrier and the outer frame. The first actuator includes a first part and a second part acting relative to each other. The first part is disposed on the carrier. The first actuator is configured to drive the optical homogenizer by the first part and the second part acting relative to each other, with a connecting position between the first flexible component and the outer frame as a fulcrum, so that the optical homogenizer is configured to swing to keep the light-receiving surface facing a same direction.

Another embodiment of the disclosure further provides a de-speckle mechanism, including: a carrier, an outer frame, a first flexible component, and a first actuator. The carrier includes an optical homogenizer. The optical homogenizer is provided with a light-receiving surface. The outer frame is disposed outside the carrier. The first flexible component is connected to the carrier and the outer frame. The first actuator is connected to the carrier or the outer frame. The first actuator is configured to drive the optical homogenizer, with a connecting position between the first flexible component and the outer frame as a fulcrum, so that the optical homogenizer is configured to swing to keep the light-receiving surface facing a same direction.

In comparison with prior art, the disclosure de-speckle mechanism provides the first flexible component as the only component connecting the carrier and the outer frame and provides the first actuator to drive the optical homogenizer, with a connecting position between the first flexible component and the outer frame as a fulcrum, so that the optical homogenizer is configured to swing in a plane direction substantially parallel to or identical to the light-receiving surface of the optical homogenizer to simplify the structure, to facilitate assembly and positioning, and to adjust a vibration path and a direction of a moving part, such that the problems in prior art can effectively avoid.

### BRIEF DESCRIPTION OF DRAWINGS

FIG. 1A is a schematic view of a three-dimensional structure of a de-speckle mechanism of one embodiment of the disclosure.

FIG. 1B is a schematic top view of a de-speckle mechanism according to an embodiment of the present disclosure;

FIG. 2A is a schematic view of a swinging mode of an optical homogenizer according to an embodiment of the present disclosure;

FIG. 2B is a schematic view of a swinging mode of an optical homogenizer according to another embodiment of the present disclosure;

FIG. 3 is the schematic view of a three-dimensional sectional structure along AA′ line of FIG. 1B;

FIG. 4A is a schematic view of a three-dimensional structure of the de-speckle mechanism according to another embodiment of the present disclosure;

FIG. 4B is a schematic top view of the de-speckle mechanism according to another embodiment of the disclosure;

FIG. 5 is a schematic view of a three-dimensional sectional structure along BB′ line of FIG. 4B;

FIG. 6 is a schematic view of a swinging mode of a de-speckle mechanism according to an embodiment of the present disclosure;

FIG. 7 is a schematic top view of a de-speckle mechanism according to another embodiment of the present disclosure; and

FIG. 8 is a schematic top view of a de-speckle mechanism according to yet another embodiment of the present disclosure.

### REFERENCE NUMERALS DESCRIPTION

10: carrier; 11: optical homogenizer; 100, 100′, 200, 200′: de-speckle mechanism; 20, 20′: outer frame; 30: first flexible component; 40, 40′: first actuator; 41, 71: first part; 42, 72: second part; 50: base; 60: second flexible component; 70, 70′: second actuator; AX1, AX2: axis; AP1, AP2: fulcrum; RD1, RD2, RD3, RD4: radial direction; CD1, CD2: circumferential direction; SP: initial position; RS: light-receiving surface.

### DETAILED DESCRIPTION

In order to make the above and other objects, features, and advantages of the present disclosure more obvious and understandable, preferred embodiments of the present disclosure will be cited below, together with the drawings, for a detailed description as follows. Furthermore, the direction terms mentioned in this disclosure, such as up, down, top, bottom, front, back, left, right, inside, outside, side layer, surrounding, center, horizontal, transverse, vertical, longitudinal, axial, radial direction, the uppermost layer, or the lowermost layer, etc., are only directions for referring to the attached drawings. Therefore, the directional terms are used to explain and understand the present disclosure, but not to limit the present disclosure. In the figures, structurally similar units are denoted by the same reference numerals.

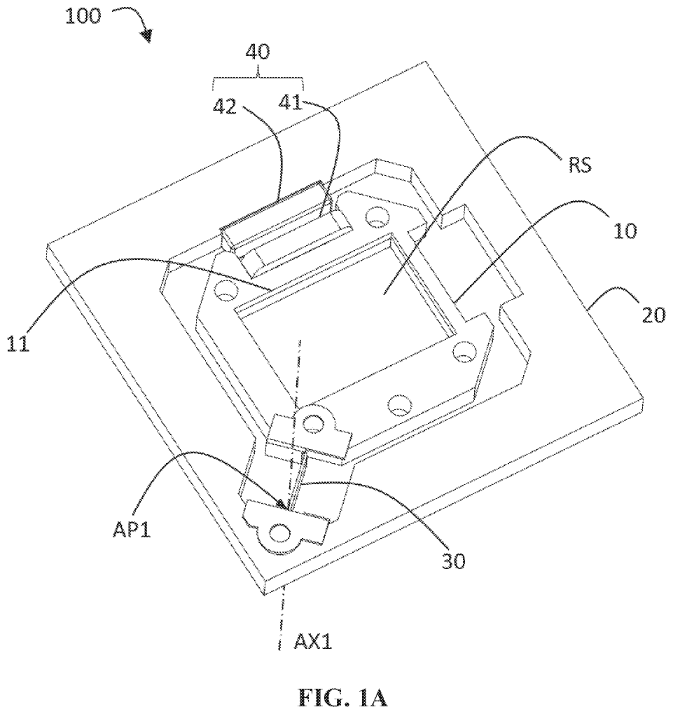

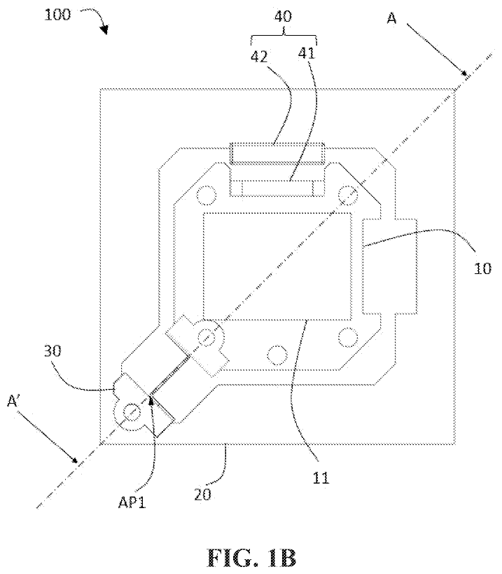

Referring to FIGS. 1A to 3, the present disclosure provides a de-speckle mechanism 100, including: a carrier 10, an outer frame 20, a first flexible component 30, and a first actuator 40. The carrier 10 includes an optical homogenizer 11, and the optical homogenizer 11 is provided with a light-receiving surface RS. The outer frame 20 is disposed outside the carrier 10. The first flexible component 30 is a substantially main component connected to the carrier 10 and the outer frame 20. The first actuator 40 includes a first part 41 and a second part 42 that act relative to each other. The first part 41 is disposed on the carrier 10. The first actuator 40 can drive the optical homogenizer 11 through the relative moving first part and second part, with a connecting position between the first flexible component 30 and the outer frame 20 as a fulcrum AP1 so that the optical homogenizer 11 is configured to swing to keep the light-receiving surface RS facing the same direction continuously.

In detail, the carrier 10 is a frame that carries and holds the optical homogenizer 11. The optical homogenizer 11 is disposed on the carrier 10. The carrier 10 is, for example, an “O”-shaped hollow frame to surround the optical homogenizer 11. In another preferred embodiment, the carrier 10 surrounds at least two sides of the optical homogenizer 11, and in other preferred embodiments, it surrounds three or four sides of the optical homogenizer 11. The carrier 10 can also be used for fixing one end of the first flexible component 30 and for fixing the first part 41 of the first actuator 40.

In detail, the outer frame 20 is disposed on the outer side of the carrier 10 adjacent to the carrier 10. For example, it is disposed on at least one side of the carrier 10 and is spaced from the carrier 10 at a distance, so that when the first actuator 40 pushes the carrier 10 to make the optical homogenizer 11 swing, there is a space near the carrier 10 for swinging. The outer frame 20 is used for fixing the other end of the first flexible component 30 so that the carrier 10 can swing through the first flexible component 30. The outer frame 20 also provides fixing of the second part 42 of the first actuator 40 such that the first part 41 and the second part 42 of the first actuator 40 are disposed opposite to each other. In one embodiment, the outer frame 20 can be used to fix the optical homogenizer 11 at a proper position in a light engine. In one embodiment, the outer frame 20 can be integrated with a frame of the light engine, which is not limited in this disclosure.

In detail, the optical homogenizer 11 is for example swinging along the circumferential direction CD1 between the radial direction RD1 and the radial direction RD2 of the axis AX1. In one embodiment, when the first actuator 40 pushes the optical homogenizer 11, a swing frequency of the optical homogenizer 11 is adjusted, for example, by controlling a vibration frequency of the first actuator 40.

In detail, depending on the type, size, and severity of speckle of the light engine, the vibration frequency of the first actuator 40 disclosed in the present disclosure is preferably greater than 0 Hz and less than 400 Hz, or a greater vibration frequency. A swing angle or amplitude of the optical homogenizer 11 is preferably greater than 0 degrees and less than 10 degrees, or a greater swing angle. A displacement of the optical homogenizer 11 is preferably greater than 0 mm and less than 5 mm, or a greater amount of displacement to effectively eliminate speckle.

In detail, the optical homogenizer 11 is used to eliminate speckle of a laser light source. The optical homogenizer is disposed such that the laser light source is irradiated on the light-receiving surface RS of the optical homogenizer and reflected back to the light path. In one embodiment of the present disclosure, the optical homogenizer 11 is a diffuser. In detail, the optical homogenizer 11 can also be a micro-lens array, a light diffusing element, or a reflective element with a micro-structured surface.

In detail, the first flexible component 30 is used to provide a flexible connection function. A flexible connection is relative to a rigid connection. In a rigid connection, there is no displacement between opposing connected members. A flexible connection, on the other hand, allows displacement between the connected parts, such as a pivot joint or a connection using elastic material. In a preferred embodiment, the first flexible component 30 is used to make the optical homogenizer 11 swing with the connecting position of the first flexible component 30 and the outer frame 20 as the fulcrum AP1, and also used to keep the light-receiving surface RS continuously facing the same direction. That is, the first flexible component 30 can provide a first degree of freedom to make the optical homogenizer 11 swing in a plane direction substantially parallel to or identical to the light-receiving surface RS of the optical homogenizer 11. For example, the first flexible component 30 is a first pivot located at the fulcrum AP1 and perpendicular to the light-receiving surface RS.

In another embodiment of the present disclosure, the first flexible component 30 is an elastic material, such as a first elastic element. In detail, the first flexible component can also be used to provide elastic restoring force for the reciprocating swing of the optical homogenizer 11. In one embodiment of the present disclosure, the first flexible component is a plate spring. One end of the plate spring is fixed to the carrier 10, and the other end of the plate spring is fixed to the outer frame 20. The plate spring can be a plate structure with “I” shaped or “Z” shaped, and a structure of “I” in the middle of the plate structure is simpler than the conventional structure.

In an embodiment of the present disclosure, the first flexible component 30 is connected to the carrier and the outer frame in the following manner: the first flexible component 30 is an essential main part connected to the carrier 10 and the outer frame 20. In detail, in order to simplify the structure, facilitate assembly and positioning, and adjust the vibration path and direction of a moving part, and effectively avoid the problems in the prior art, the first flexible component 30 is a main part used to connect the carrier 10 and the outer frame. 20, but does not exclude other components that assist the first flexible component 30, such as an outer cover, a guide groove, or a guide rod, etc. In another embodiment of the present disclosure, the first flexible component 30 is a first elastic component, which is the only component connecting the carrier 10 and the outer frame 20.

The setting of fixed points of the first actuator 40 and the first flexible component 30 of the present disclosure can achieve “the optical homogenizer 11 swings in a plane direction substantially parallel to or identical to the light-receiving surface RS of the optical homogenizer 11” and is not easy to cause up and down swing. In detail, when the de-speckle mechanism 100 is operating, the fulcrum AP1 is a fixed rotation point, and the actuator 40 can be regarded as a dynamic support point when the actuator 40 is energized. By controlling frequency, oscillating angle, and displacement, the purpose of the optical homogenizer 11 swinging substantially parallel to the light-receiving surface RS can achieve.

In detail, the first actuator 40 is used to push the optical homogenizer to swing. In one embodiment of the present disclosure, a first part 41 and a second part 42 of the first actuator 40, for example, is of a magnet and a coil that are correspondingly interchangeable. The magnet and the coil are a set of actuators, which can be controlled and apply force to push the carrier 10 to swing or make the carrier 10 swing through the first flexible component, such as a plate spring.

In another embodiment of the present disclosure, the first part 41 and the second part 42 of the first actuator 40, for example, is of a magnetic conduction element and an electromagnet that are correspondingly interchangeable. The magnetic conductive element and the electromagnet are a set of actuators, which can be controlled to apply force to push the carrier 10 to swing or to make the carrier 10 swing through the first flexible component, such as a plate spring.

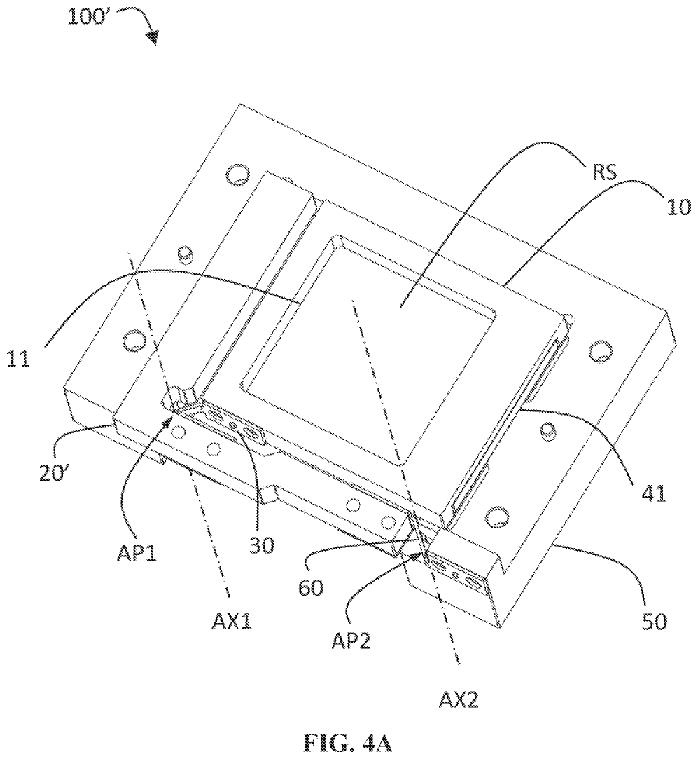

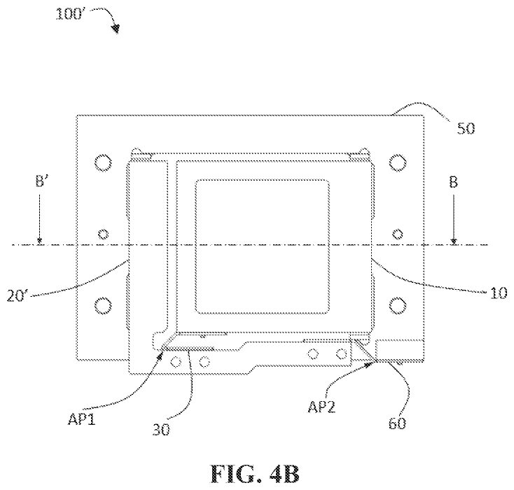

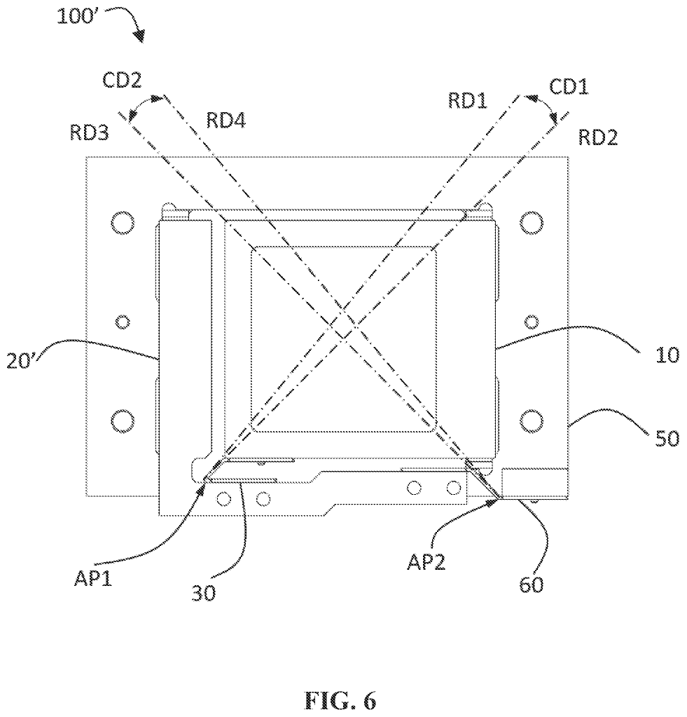

In detail, the first actuator 40 of the de-speckle mechanism 100, for example, provides the swing of the optical homogenizer 11 in the first degree of freedom. In addition, the optical homogenizer 11 can also swing in a second degree of freedom. Referring to FIG. 4A to FIG. 6, the de-speckle mechanism 100′ described in one embodiment of the present disclosure further includes a base 50, a second flexible component 60, and a second actuator 70. One end of the second flexible component 60 is connected to the base 50, and the other end is connected to the outer frame 20′. The second actuator 70 can drive the optical homogenizer 11 to swing radially with a connecting position of the second flexible component 60 and the base 50 as a fulcrum AP2. In detail, the optical homogenizer 11 oscillates along the circumferential direction CD2 between a radial direction RD3 and the radial direction RD4 of the axis AX2, for example. That is, the second flexible component 60 and the second actuator 70 provide the second degree of freedom for the optical homogenizer 11 to swing.

For example, the oscillation frequency of the optical homogenizer 11 in the second degree of freedom is adjusted by controlling the vibration frequency of the second actuator 70, when the second actuator 70 of the disclosure pushes the optical homogenizer 11.

In detail, the base 50 is disposed outside the outer frame 20′ and adjacent to the outer frame 20′. For example, it is disposed on at least one side of the outer frame 20′ and is spaced from the outer frame 20′ by a distance to provide a space near the outer frame 20′ for the second actuator 70 pushing the outer frame 20′ to make the optical homogenizer 11 to swing. The base 50 is used for fixing one end of the second flexible component 60 so that the outer frame 20′ can swing through the second flexible component 60. In one embodiment, the base 50 can be used to fix the optical homogenizer 11 at a proper position in the light engine. In one embodiment, the base 50 may be integrated with a frame of the light engine, which is not limited in the present disclosure.

In detail, the second flexible component 60 is used to provide a flexible connection function. A flexible connection is relative to a rigid connection. In a rigid connection, there is no displacement between opposing connected members. A flexible connection allows displacement between the connected parts, such as a pivot joint or a connection using elastic material. In a preferred embodiment, the second flexible component 60 is used to make the optical homogenizer 11 swing with the connection position of the second flexible component 60 and the base 50 as the fulcrum AP2, and further used to keep the light-receiving surface RS continuously facing the same direction. That is, the second flexible component 60 can provide a second degree of freedom to make the optical homogenizer 11 swing in a plane direction that is substantially parallel to or identical to the light-receiving surface RS of the optical homogenizer 11. For example, the second flexible component 60 is a second pivot located at the fulcrum AP2 and perpendicular to the light-receiving surface RS.

In another embodiment of the present disclosure, the second flexible component 60 is an elastic material, such as a second elastic component. In detail, the second elastic component can also be used to provide the elastic restoring force for the reciprocating swing of the outer frame 20′. In one embodiment of the present disclosure, the second elastic component is a plate spring. One end of the plate spring is fixed to the outer frame 20′, and the other end is fixed to the base 50.

The plate spring can be a plate structure with “I” shaped or “Z” shaped, and the “I” structure in the middle of the plate structure is simpler than the conventional structure.

In an embodiment of the present disclosure, the second flexible component 60 is connected to the outer frame 20′ and the base 50 in such a way that the second flexible component 60 is a substantial main part connected to the outer frame 20′ and the base 50. In detail, in order to simplify the structure, facilitate assembly and positioning, and adjust the vibration path and direction of the moving part, and effectively avoid the problems in the prior art, the second flexible component 60 is responsible for main task of connecting the outer frame 20′ and the base 50. However, the disclosure does not exclude other components that assist the second flexible component 60, such as a cover, a guide groove, or a guide rod. In another embodiment of the present disclosure, the second flexible component 60 is a second elastic component, which is the only component connecting the outer frame 20′ and the base 50.

Fixed points of arrangement of the second actuator 70 and the second flexible component 60 of the present disclosure can achieve “the optical homogenizer 11 swings in a plane direction substantially parallel to or identical to the light-receiving surface RS of the optical homogenizer 11” and is not easy to cause up and down swing. In detail, when the de-speckle mechanism 100′ is operating, the fulcrum AP2 is a fixed rotation point, and the second actuator 70 can be regarded as a dynamic support point when the second actuator 70 is energized. By controlling the vibration frequency, swing angle, and the displacement, the purpose of the optical homogenizer 11 swinging substantially parallel to the light-receiving surface RS can be achieved.

In detail, the second actuator 70 is used to push the optical homogenizer to swing. In detail, depending on the type, size, and severity of the speckle, a vibration frequency of the second actuator 70 in the present disclosure is preferably greater than 0 Hz and less than 400 Hz, or a greater vibration frequency. A swing angle or amplitude of the optical homogenizer 11 is preferably greater than 0 degrees and less than 10 degrees, or a greater swing angle. The displacement of the optical homogenizer 11 is preferably greater than 0 mm and less than 5 mm, or a greater displacement to effectively eliminate speckle.

In one embodiment of the present disclosure, the second actuator 70 includes a first part 71 and a corresponding second part 72. The first part 71 is disposed on the outer frame 20′. The base 50 also provides fixing of the second portion 72 of the second actuator 70 such that the first portion 71 of the second actuator 70 is opposite to the second portion 72.

In one embodiment of the present disclosure, the first part 71 and the second part 72 of the second actuator 70, for example, are a magnet and a coil that are correspondingly interchangeable. The magnet and the coil are a group of actuators, which can be controlled to apply force to push the outer frame 20′ to swing or to make the outer frame 20′ swing through a second flexible component, such as a plate spring.

In another embodiment of the present disclosure, the first part 71 and the second part 72 of the second actuator 70, for example, are a magnetic conduction element and an electromagnet that are correspondingly interchangeable. The magnetic conductive element and the electromagnet are a set of actuators, which can be controlled to apply force to push the outer frame 20′ to swing or to make the outer frame 20′ swing through a second flexible component, such as a plate spring.

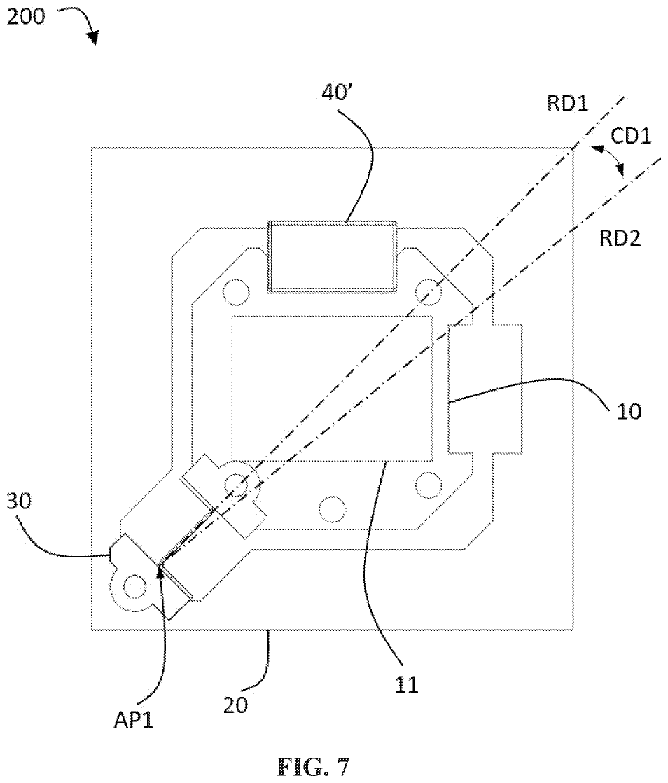

Referring to FIG. 7, the present disclosure also provides a de-speckle mechanism 200, including: a carrier 10, an outer frame 20, a first flexible component 30, and a first actuator 40′. The carrier 10 includes an optical homogenizer 11. The optical homogenizer is provided with a light receiving-surface RS. The outer frame 20 is disposed outside the carrier 10. The first flexible component 30 is a substantially main component connected the carrier 10 and the outer frame 20. The first actuator 40′ is connected to the carrier 10 or the outer frame 20. The first actuator 40′ can drive the optical homogenizer 11 to swing, with a connecting position of the first flexible component 30 and the outer frame 20 as a fulcrum AP1, so as to maintain the light-receiving surface RS of the optical homogenizer of 11 continues to face the same direction.

In detail, the carrier 10 is a frame that carries and holds the optical homogenizer 11. The optical homogenizer 11 is disposed on the carrier 10. The carrier 10 is, for example, an “O” shaped hollow frame to surround the optical homogenizer 11. In another preferred embodiment, the carrier 10 surrounds at least two sides of the optical homogenizer 11, and in other preferred embodiments, it surrounds three or four sides of the optical homogenizer 11. The carrier 10 can also be used for fixing one end of the first flexible component 30 and providing fixing of the first actuator 40′ so that the first actuator 40′ is disposed on the carrier 10 and pushed against the outer frame 20 to make the carrier 10 swing relative to the outer frame 20.

In detail, the outer frame 20 is disposed outside the carrier 10 and adjacent to the carrier 10. For example, it is disposed on at least one side of the carrier 10 and is spaced from the carrier 10 at a distance, so that there is a space near the carrier 10 for the optical homogenizer 11 to swing when the first actuator 40 pushes the carrier 10 to make the optical homogenizer 11 swing. The outer frame 20 is used for fixing the other end of the first flexible component 30 so that the carrier 10 can swing through the first flexible component 30. The outer frame 20 can also provide the first actuator 40′ to be fixed so that the first actuator 40′ is disposed on the outer frame 20 to push the carrier 10. In one embodiment, the outer frame 20 can be used to fix the optical homogenizer 11 at a proper position in the light engine. In one embodiment, the outer frame 20 can be integrated with a frame of a light engine, which is not limited in this disclosure.

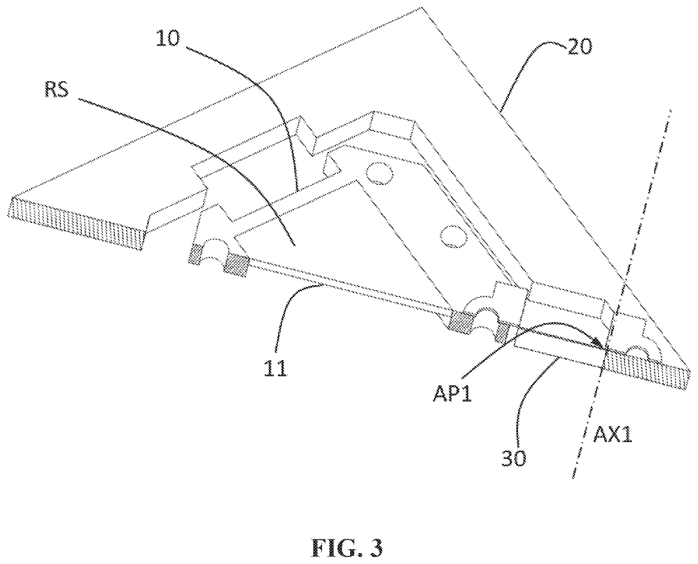

An axis of the de-speckle mechanism 200 is similar to the axis AX1 in FIG. 3, please refer to FIG. 3 and FIG. 7. The optical homogenizer 11 is configured to swing between a radial direction RD1 and a radial direction RD2 of the axis AX1 along the circumferential direction CD1. In one embodiment, when the actuator 40′ pushes the optical homogenizer 11, the oscillation frequency of the optical homogenizer 11 is adjusted for, example, by controlling the vibration frequency of the actuator 40′. In detail, the main difference between the de-speckle mechanism 200 and the de-speckle mechanism 100 is that the first actuator 40′ of the de-speckle mechanism 200 is a contact actuator, and there is only one main component, which is different from the de-speckle mechanism that the first actuator 40 of 100 includes two parts. Therefore, other components in the de-speckle mechanism 200 the same as those of the de-speckle mechanism 100 can refer to the foregoing description.

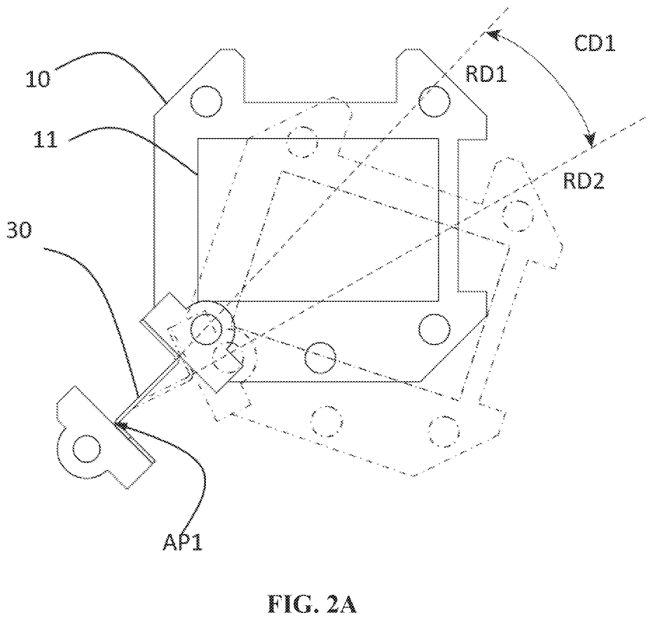

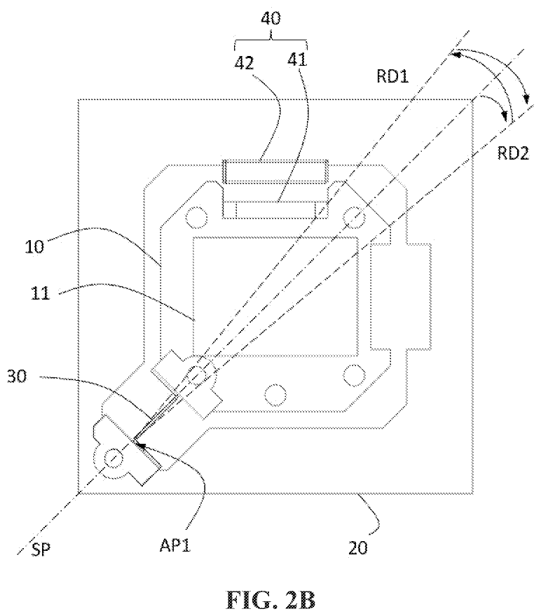

In addition to FIG. 7, the swing of the optical homogenizer 11 can also refer to the description of the de-speckle mechanism 100 and FIGS. 2A and 2B. In detail, the radial direction RD1 is, for example, an initial direction along the first flexible component 30 as shown in FIG. 2A. The optical homogenizer 11 is push from the radial direction RD1 to the radial direction RD2 by the first actuator 40′ and then pulled back to the radial direction RD1 to perform a reciprocating swing, but the present disclosure is not limited thereto. Referring to FIG. 2B, the radial direction RD1 and the radial direction RD2 can also be respectively located on both sides of the initial position SP of the first flexible component 30, that is, when the optical homogenizer 11 is pushed by the first actuator 40, the optical homogenizer 11 moves from the initial position SP of the flexible component 30 swings toward the radial direction RD2, and then the first actuator 40 pulls back the optical homogenizer 11 to the initial position SP of the first flexible component 30 and continues to swing toward the radial direction RD1, and then the first actuator 40 push the optical homogenizer 11 to swing back to the initial position SP of the first flexible component 30 to carry out reciprocating swing in this way.

In detail, depending on the type, size, and severity of speckle of the light engine, a vibration frequency of the first actuator 40′ disclosed in the present disclosure is preferably greater than 0 Hz and less than 400 Hz, or a greater frequency. The swing angle or amplitude of the optical homogenizer 11 is preferably greater than 0 degrees and less than 10 degrees, or a greater swing angle. The displacement of the optical homogenizer 11 is preferably greater than 0 mm and less than 5 mm, or a greater displacement to effectively eliminate speckle.

In detail, the optical homogenizer 11 is used to eliminate speckle of a laser light source. The optical homogenizer is disposed such that the laser light source is irradiated on the light-receiving surface RS of the optical homogenizer and reflected back to the light path. In one embodiment of the present disclosure, the optical homogenizer 11 is a sheet of diffuser. In detail, the optical homogenizer 11 can also be a micro-lens array, a light diffusing element, or a reflective element with a micro-structured surface.

In detail, the first flexible component 30 is used to provide a flexible connection function. A flexible connection is relative to a rigid connection. In a rigid connection, there is no displacement between opposing connected members. A flexible connection, on the other hand, allows displacement between the connected parts, such as a pivot joint or a connection using elastic material. In a preferred embodiment, the first flexible component 30 is used to make the optical homogenizer 11 swing with the connecting position of the first flexible component 30 and the outer frame 20 as the fulcrum AP1, and further used to keep the light-receiving surface RS continuously facing the same direction. That is, the first flexible component 30 can provide a first degree of freedom to make the optical homogenizer 11 swing in a plane direction substantially parallel to or identical to the light receiving surface RS of the optical homogenizer 11. For example, the first flexible component 30 is a first pivot located at the fulcrum AP1 and perpendicular to the light-receiving surface RS.

In another embodiment of the present disclosure, the first flexible element 30 is an elastic material, such as a first elastic element. In detail, the first elastic component can also be used to provide elastic restoring force for the reciprocating swing of the optical homogenizer 11. In one embodiment of the present disclosure, the first flexible component is a plate spring. One end of the plate spring is fixed to the carrier 10, and the other end is fixed to the outer frame 20. The plate spring can be a plate structure with “I” shaped or “Z” shaped, and the structure “I” in the middle of the plate structure is simpler than the conventional structure.

In addition to FIG. 7, the swing of the optical homogenizer 11 can also refer to the description of the de-speckle mechanism 100 and FIGS. 2A and 2B. In detail, in another embodiment of the present disclosure, when the first flexible element 30 is a first elastic element, the radial direction RD1 is, for example, along an initial direction of the first flexible element 30 as shown in FIG. 2A, that is, the position of the first flexible component when no force is applied. The optical homogenizer 11 is pushed from the radial direction RD1 to the radial direction RD2 by the first actuator 40, and then swings back to the radial direction RD1 under the action of the elastic restoring force of the first flexible component 30 to perform reciprocating swing in this way, but the disclosure is not limited thereto. Referring to FIG. 2B, the radial direction RD1 and the radial direction RD2 can also be respectively located on both sides of the initial position SP of the first flexible component 30, that is, when the optical homogenizer 11 is pushed by the first actuator 40, the optical homogenizer 11 swings from the initial position SP of the flexible component 30 to the radial direction RD2, and then swings back to the initial position SP of the first flexible component 30 by the elastic force of the first flexible component 30 and continues to swing to the radial direction RD1, and then by the elastic force of the first flexible component 30 or force of the first actuator 40, swings back to the initial position SP of the first flexible component 30 to perform reciprocating swing in this way.

In an embodiment of the present disclosure, the first flexible component 30 is connected to the carrier and the outer frame in the following manner: the first flexible component 30 is an essential main part connected to the carrier 10 and the outer frame 20. In detail, in order to simplify the structure, facilitate assembly and positioning, and adjust the vibration path and direction of the moving part, and effectively avoid the problems in the prior art, the first flexible component 30 is mainly used to connect the carrier 10 and the outer frame. 20, but does not exclude other components that assist the first flexible component 30, such as an outer cover, a guide groove, or a guide rod, etc. In another embodiment of the present disclosure, the first flexible component 30 is a first elastic component, which is the only component connecting the carrier 10 and the outer frame 20.

Fixed points of arrangement of the first actuator 40′ and the first flexible component 30 in the present disclosure can achieve “the optical homogenizer 11 swings substantially parallel to or identical to the light-receiving surface RS of the optical homogenizer 11” and not easy to cause up and down swing. In detail, when the de-speckle mechanism 200 operates, the fulcrum AP1 is a fixed rotation point, and the actuator 40 can be regarded as a dynamic support point when the actuator 40 is energized. Purpose of oscillating the optical homogenizer 11 substantially parallel to the light-receiving surface RS can achieve by adjusting frequency, oscillating angle, and displacement.

In detail, the first actuator 40′ is used to provide a thrust for the optical homogenizer 11 to swing. In one embodiment of the present disclosure, the first actuator 40′ is a contact actuator, such as a piezoelectric element. The piezoelectric element is, for example, disposed on the outer frame 20 or the carrier 10. The piezoelectric element is used to make the diffuser vibrate at a small angle through the first flexible component 30. The structure is simple, and the volume is smaller than the conventional motor-rotating wheel diffuser structure.

In another embodiment of the present disclosure, the first actuator 40′ is a contact actuator, such as a voice coil motor. The voice coil motor is, for example, disposed on the outer frame 20 or the carrier 10. Similarly, using a voice coil motor to oscillate the diffuser at a small angle through the first flexible component 30 has a simple structure and a smaller volume than conventional motor-rotating wheel-shaped diffuser structures.

In other embodiments of the present disclosure, the first actuator 40′ is a contact actuator, such as a stepping motor or a servo motor.

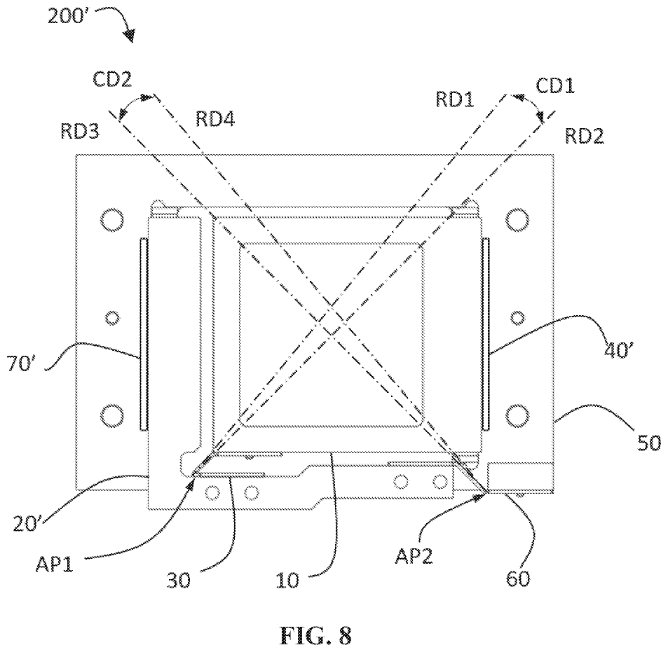

In detail, the first actuator 40′ of the de-speckle mechanism 200, for example, provides the swing of the optical homogenizer 11 in the first degree of freedom. In addition, the optical homogenizer 11 can also swing in a second degree of freedom. Referring to FIG. 8, the de-speckle mechanism 200′ in one embodiment of the present disclosure further includes a base 50, a second flexible component 60, and a second actuator 70′. The one end of the second flexible component 60 is connected to the base 50, and the other end is connected to the outer frame 20′. The second actuator 70′ drives the optical homogenizer 11, with a connecting position between the second flexible component 60 and the base 50 as a fulcrum AP2, to swing along a second radial direction. That is, the second flexible component 60 and the second actuator 70′ provide the second degree of freedom for the optical homogenizer 11 to swing.

The swing of the optical homogenizer 11 on the second degree of freedom frequency is, for example, adjusted by controlling the vibration frequency of the second actuator 70′, when the second actuator 70′ of the disclosure pushes the optical homogenizer 11.

In detail, the axis position of the de-speckle mechanism 200′ is similar to the axis AX2 of the de-speckle mechanism 100′. Referring to FIG. 8 and FIG. 4A, the optical homogenizer 11 swings along a second radial direction is that swings between the radial direction RD3 and the radial direction RD4 of axis AX2 along the circumferential direction CD2.

In detail, the base 50 is disposed outside the outer frame 20′ and adjacent to the outer frame 20′. For example, it is disposed on at least one side of the outer frame 20′ and is spaced from the outer frame 20′ by a distance, so that there is a space near the outer frame 20′ for the optical homogenizer 11 swinging when the second actuator 70′ pushes the outer frame 20′ to make the optical homogenizer 11 swing. The base 50 is used for fixing one end of the second flexible component 60 so that the outer frame 20′ can swing through the second flexible component 60. In one embodiment, the base 50 can be used to fix the optical homogenizer 11 at a proper position in the light engine. In one embodiment, the base 50 may be integrated with a frame of the light engine, which is not limited in the present disclosure.

In detail, the second flexible component 60 is used to provide a flexible connection function. A flexible connection is relative to a rigid connection. In a rigid connection, there is no displacement between opposing connected members. A flexible connection allows displacement between the connected parts, such as a pivot joint or a connection using elastic material. In a preferred embodiment, the second flexible component 60 is used to make the optical homogenizer 11 swing with the connection position of the second flexible component 60 and the base 50 as the fulcrum AP2, and further used to keep the light-receiving surface RS continuously facing the same direction. That is, the second flexible component 60 can provide a second degree of freedom to make the optical homogenizer 11 swing in a plane direction that is substantially parallel to or identical to the light-receiving surface RS of the optical homogenizer 11. For example, the second flexible component 60 is a second pivot located at the fulcrum AP2 and perpendicular to the light-receiving surface RS.

In another embodiment of the present disclosure, the second flexible component 60 is an elastic material, such as a second elastic component. In detail, the second elastic component can also be used to provide the elastic restoring force for the reciprocating swing of the outer frame 20′. In one embodiment of the present disclosure, the second elastic component is a plate spring. One end of the plate spring is fixed to the outer frame 20′, and the other end is fixed to the base 50.

The plate spring can be a plate structure with “I” shaped or “Z” shaped, and the “I” structure in the middle of the plate structure is simpler than the conventional structure.

In an embodiment of the present disclosure, the second flexible component 60 is connected to the outer frame 20′ and the base 50 in such a way that the second flexible component 60 is a substantial main part connected to the outer frame 20′ and the base 50. In detail, in order to simplify the structure, facilitate assembly and positioning, and adjust the vibration path and direction of the moving part, and effectively avoid the problems in the prior art, the second flexible component 60 is mainly responsible for connecting the outer frame 20′ and the base 50, but does not exclude other components that assist the second flexible component 60, such as a cover, a guide groove, or a guide rod. In another embodiment of the present disclosure, the second flexible component 60 is a second elastic component, which is the only component connecting the outer frame 20′ and the base 50.

Fixed points of the setting of the second actuator 70′ and the second flexible component 60 of the present disclosure can achieve “the optical homogenizer 11 swings substantially parallel to or identical to the light-receiving surface RS of the optical homogenizer 11” and not easy to cause up and down swing. In detail, when the de-speckle mechanism 100′ is in operation, the fulcrum AP2 is a fixed rotation point, and the second actuator 70′ can be regarded as a dynamic support point when the second actuator 70′ is energized. By controlling the vibration frequency, the swing angle, and the displacement, the purpose of the optical homogenizer 11 swinging substantially parallel to the direction of the light-receiving surface RS can be achieved.

In detail, the second actuator 70′ is used to provide thrust for the optical homogenizer 11 to swing. In detail, depending on the type, size, and severity of the speckle, the vibration frequency of the second actuator 70′ in the present disclosure is preferably greater than 0 Hz and less than 400 Hz, or a greater vibration frequency. The swing angle or amplitude of the optical homogenizer 11 is preferably greater than 0 degrees and less than 10 degrees, or a greater swing angle. the displacement of the optical homogenizer 11 is preferably greater than 0 mm and less than 5 mm, or a greater displacement to effectively eliminate speckle.

In one embodiment of the present disclosure, the second actuator 70′ is a contact actuator, such as a piezoelectric element. The piezoelectric element is, for example, disposed on the outer frame 20′ or the base 50. The piezoelectric element is used to make the diffuser vibrate at a small angle through the second flexible component 60. The structure is simple, and the volume is smaller than that of the conventional motor-rotating wheel diffuser structure.

In one embodiment of the present disclosure, the second actuator 70′ is a contact actuator, such as a voice coil motor. The voice coil motor is, for example, disposed on the outer frame 20′ or the base 50. Similarly, using a voice coil motor to make the diffuser vibrate at a small angle through the second flexible component 60 has a simple structure and a smaller volume than conventional motor-rotating wheel diffuser structures.

In other embodiments of the present disclosure, the second actuator 70′ is a contact actuator, such as a stepping motor or a servo motor.

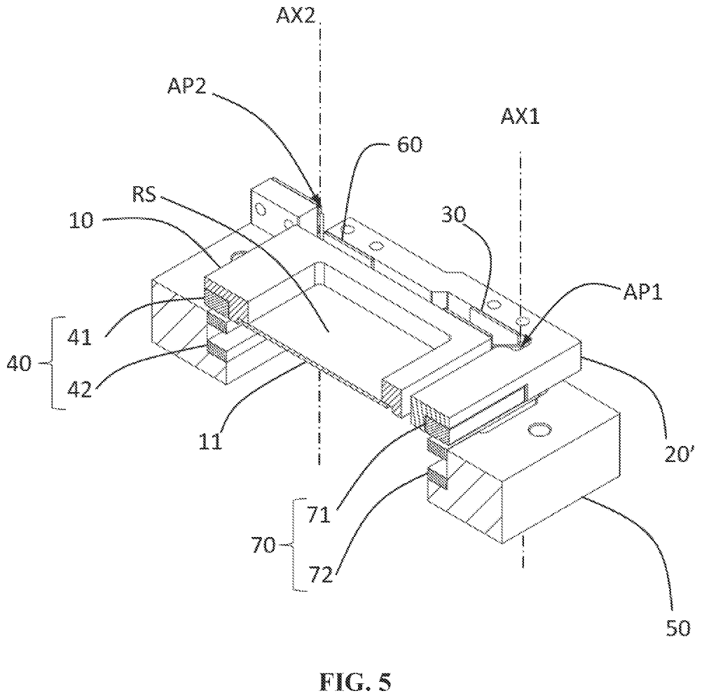

The second actuator 70′ shown in FIG. 8 is a contact actuator, but in one embodiment of the present disclosure, similar to the second actuator shown in FIG. 5, the second actuator in FIG. 8 can be a non-contact actuator, for example, includes a corresponding first part 71 and a second part 72, and the first part 71 is disposed on the outer frame 20′. In detail, because the second actuator is responsible for driving the entire structure including the outer frame 20′, the first flexible component 30, the carrier 10, and the optical homogenizer 11, depending on the actual weight of the entire structure, it may need a larger driving force, an actuator with a larger driving force can be selected, for example, the driving force of the second actuator is selected to be greater than that of the first actuator.

In detail, in other embodiments of the present disclosure, both the second actuator and the first actuator may be non-contact actuators or both may be contact actuators, or one is a contact actuator, and the other is a non-contact actuator, which is not limited in this disclosure. Non-contact actuators are, for example interchangeable magnets and coils or interchangeable magnetic elements and electromagnets. Contact actuators are, for example piezoelectric elements, stepper motors, servo motors, or voice coil motors.

In one of the embodiments of the present disclosure, the first part 71 and the second part 72 of the second actuator 70 are, for example a magnet and a coil that are correspondingly interchangeable. The magnet and the coil are a set of actuators, which can be controlled to apply force to push the outer frame 20′ to swing or to make the outer frame 20′ swing through a second flexible component, such as a plate spring.

In another embodiment of the present disclosure, the first part 71 and the second part 72 of the second actuator 70 are, for example, a magnetic conduction element and an electromagnet that are correspondingly interchangeable. The magnetic conductive element and the electromagnet are a set of actuators, which can be controlled to apply force to push the outer frame 20′ to swing or to make the outer frame 20′ swing through a second flexible component, such as a plate spring.

The present disclosure can be applied to the architecture of a lighting combination system of a laser projector or other systems using a laser light source. The display element may be a digital light processing element (DLP), a three-chip liquid crystal display element (3LCD), or a liquid crystal display on silicon (Lcos). The speckle effect of the laser light source will cause light spots on the screen. This disclosure makes the diffuser swing in the lighting system to achieve the effect of eliminating speckles.

Compared with the prior art, the de-speckle mechanism in the present disclosure provides the first flexible component as the main component connecting the carrier and the outer frame, and the optical homogenizer is driven by the first actuator, with the connecting position of the first flexible component and the outer frame as a fulcrum to swings in a plane direction substantially parallel to or identical to the light-receiving surface of the optical homogenizer, which can simplify the structure, facilitate assembly and positioning, and adjust the vibration path and direction of the moving part, effectively avoid the problems in the prior art.

Although the disclosure has been shown and described with respect to one or more implementations, equivalent alterations and modifications will occur to those skilled in the art upon the reading and understanding of this specification and the annexed drawings. This disclosure includes all such modifications and variations and is limited only by the scope of the appended claims. In particular with respect to the various functions performed by the elements described above, terminology used to describe such elements is intended to correspond to any element (unless otherwise indicated) that performs the specified function of the element (e.g., which is functionally equivalent), even if there are no structural equivalents to the disclosed structures that perform the functions shown herein in the exemplary implementations of the specification. Furthermore, although a particular feature of this specification has been disclosed with respect to only one of several implementations, such a feature may be combined with one or more other features of other implementations that are desirable and advantageous for a given or particular application. Moreover, to the extent that the terms “comprises”, “has”, “comprising” or variations thereof are used in the detailed description or the claims, such terms are intended to be encompassed in a manner similar to the term “comprising”.

The above are only preferred embodiments of the present disclosure, and it should be pointed out that for those of ordinary skill in the art, without departing from the principle of the present disclosure, some improvements and modifications can also be made, and these improvements and modifications should also be regarded as protection scope of this disclosure.

What is claimed is:

1. A de-speckle mechanism, comprising:
a carrier;
an optical homogenizer provided with a light-receiving surface and disposed on the carrier;
an outer frame disposed adjacent to the carrier;
a first flexible component, wherein the first flexible component is an only component connecting the carrier and the outer frame; and
a first actuator comprising a first part and a second part acting relative to each other, wherein the first part is disposed on the carrier, the first actuator is configured to drive the optical homogenizer, with a connecting position between the first flexible component and the outer frame as a fulcrum, so that the optical homogenizer is configured to swing in a plane direction substantially parallel to or identical to the light-receiving surface of the optical homogenizer.

2. The de-speckle mechanism according to claim 1, wherein the first flexible component is a plate spring.

3. The de-speckle mechanism according to claim 1, wherein the optical homogenizer is a diffuser.

4. The de-speckle mechanism according to claim 1, wherein the first part and the second part of the first actuator are of a magnet and a coil that are correspondingly interchangeable.

5. The de-speckle mechanism according to claim 1, wherein the first part and the second part of the first actuator are of a magnetic conducting element and an electromagnet that are correspondingly interchangeable.

6. A de-speckle mechanism, comprising:
a carrier comprising an optical homogenizer, wherein the optical homogenizer is provided with a light-receiving surface;
an outer frame disposed outside the carrier;
a first flexible component, wherein the first flexible component is a main component substantially connecting the carrier and the outer frame; and
a first actuator comprising a first part and a second part acting relative to each other, wherein the first part is disposed on the carrier, the first actuator is configured to drive the optical homogenizer by the first part and the second part acting relative to each other, with a connecting position between the first flexible component and the outer frame as a fulcrum, so that the optical homogenizer is configured to swing to keep the light-receiving surface facing a same direction.

7. The de-speckle mechanism according to claim 6, wherein the first flexible component is a plate spring.

8. The de-speckle mechanism according to claim 6, wherein the optical homogenizer is a diffuser.

9. The de-speckle mechanism according to claim 6, wherein the first part and the second part of the first actuator are of a magnet and a coil that are correspondingly interchangeable.

10. The de-speckle mechanism according to claim 6, wherein the first part and the second part of the first actuator are of a magnetic conducting element and an electromagnet that are correspondingly interchangeable.

11. The de-speckle mechanism according to claim 6, further comprising a base, a second flexible component, and a second actuator, wherein one end of the second flexible component is connected to the base, the other end of the second flexible component is connected to the outer frame, the second actuator is configured to drive the optical homogenizer, with a connecting position between the second flexible component and the base as a fulcrum, so that the optical homogenizer is configured to swing in a plane direction substantially parallel to or identical to the light-receiving surface of the optical homogenizer.

12. The de-speckle mechanism according to claim 11, wherein the second actuator is provided with a first part and a second part corresponding to each other, wherein the first part of the second actuator is disposed on the outer frame, the first part and the second part of the second actuator are of a magnet and a coil that are correspondingly interchangeable.

13. The de-speckle mechanism according to claim 11, wherein the second actuator is provided with a first part and a second part corresponding to each other, wherein the first part of the second actuator is disposed on the outer frame, the first part and the second part are of a magnetic conducting element and an electromagnet that are correspondingly interchangeable.

14. A de-speckle mechanism, comprising:
a carrier comprising an optical homogenizer, wherein the optical homogenizer is provided with a light-receiving surface;
an outer frame disposed outside the carrier;
a first flexible component connected to the carrier and the outer frame; and
a first actuator connected to the carrier or the outer frame, wherein the first actuator is configured to drive the optical homogenizer, with a connecting position between the first flexible component and the outer frame as a fulcrum, so that the optical homogenizer is configured to swing to keep the light-receiving surface facing a same direction.

15. The de-speckle mechanism according to claim 14, wherein the first actuator is selected from a group consisting of a piezoelectric element, a stepper motor, a servo motor, and a voice coil motor.

16. The de-speckle mechanism according to claim 14, wherein the first flexible component is a plate spring.

17. The de-speckle mechanism according to claim 14, further comprising a base, a second flexible component, and a second actuator, wherein one end of the second flexible component is connected to the base, the other end of the second flexible component is connected to the outer frame, the second actuator is configured to drive the optical homogenizer, with a connecting position between the second flexible component and the base as a fulcrum, so that the optical homogenizer is configured to swing in a plane direction substantially parallel to or identical to the light-receiving surface of the optical homogenizer.

18. The de-speckle mechanism according to claim 17, wherein the second actuator is provided with a first part and a second part corresponding to each other, wherein the first part of the second actuator is disposed on the outer frame, the first part and the second part of the second actuator are of a magnet and a coil that are correspondingly interchangeable.

19. The de-speckle mechanism according to claim 17, wherein the second actuator is provided with a first part and a second part corresponding to each other, wherein the first part of the second actuator is disposed on the outer frame, the first part and the second part are of a magnetic conducting element and an electromagnet that are correspondingly interchangeable.

20. The de-speckle mechanism according to claim 17, wherein the second actuator is selected from a group consisting of a piezoelectric element, a stepper motor, a servo motor, and a voice coil motor.
